(19) United States
(12) Patent Application Publication
(10) Pub. No.: US 2023/0301281 A1
(43) Pub. Date: Sep. 28, 2023

(54) FRAMED THREE-POINT LIFT NET

(71) Applicant: Randy Hicks, Bolivar, MO (US)

(72) Inventor: Randy Hicks, Bolivar, MO (US)

(21) Appl. No.: 17/705,350

(22) Filed: Mar. 27, 2022

(51) Int. Cl. A01K 75/00

(52) U.S. Cl. CPC A01K 75/005

(57) ABSTRACT

A framed three-point lift net for lifting one or more fish out of the water to a user located at an elevated fishing venue is presented. The framed three-point lift net may comprise a frame, a net, and a lifting cord. The framed three-point lift net may be a fishing net that is adapted to lift one or more fish out of water and up to a user located at an elevated fishing venue. As non-limiting examples, the elevated fishing venue may be a pier, a bluff, a dam, or a boat. The net may be held open by the frame. The net may be adapted to be positioned under the one or more fish and then lifted as the frame is raised by pulling up on the lifting cord. The lifting cord may attach to the frame at three points.

### FIELD OF THE INVENTION

This invention relates to fishing. More particularly, it relates to a device for lifting one or more netted fish to a user at an elevated venue.

### BACKGROUND

Fishing is an ancient practice that dates back to at least the beginning of the Upper Paleolithic period about 40,000 years ago. Fishing is the activity of trying to catch fish. Fish are often caught in the wild but may also be caught from stocked bodies of water. Techniques for catching fish include hand gathering, spearing, netting, angling and trapping. “Fishing” may include catching aquatic animals other than fish, such as mollusks, cephalopods, crustaceans, and echinoderms. The term is not normally applied to catching farmed fish, or to aquatic mammals, such as whales where the term whaling is more appropriate. In addition to being caught to be eaten, fish are caught as recreational pastimes. Fishing tournaments are held, and caught fish are sometimes kept as preserved or living trophies. Recreational, commercial and artisanal fishers use different techniques, and also, sometimes, the same technique.

Fishing techniques can be contrasted with fishing tackle. Fishing tackle refers to the physical equipment that is used when fishing, whereas fishing techniques. A drop-net, one type of fishing techniques, is one the best devices known, for one-man bait catching. The pier net is without doubt the best method to land a fish from a pier. Most pier nets will be what is commonly known as a drop net. These nets are easy to use from a bridge or pier, or any place over water.

Fishing from a pier gives you access to a wide range of different species which means there is a lot of different pier fishing gear and tackle required if you want to target every type of fish in every type of water conditions.

A good drop net for pier fishing (pier net) will have a strong rope attached to it and a solid metal frame. This gives them the ability to pull up some fairly heavy fish. Drop nets take all the guess work out of landing fish from a pier. Lower it down, allow the fish to move over the mouth of the net and then haul them straight up.

There are several problems associated with the current design of drop nets. Existing drop nets are comprised of a heavy steel frame (usually round) and strong well stitched mesh. They are not collapsible and therefore not easily portable usually requiring more than one person to transport. The color of the existing nets is not easily identifiable in the water and is not quick to replace.

Accordingly, and in light of the foregoing, it would be desirable to have an easily portable fishing net that provides greater efficiency and is quick, easy and effective to use. It is also desirable to have a device that can lift fish to an elevated position of a fisherman efficiently and cost effectively.

### DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is an isometric view of a framed three point lift net 100, according to an embodiment of the present invention;

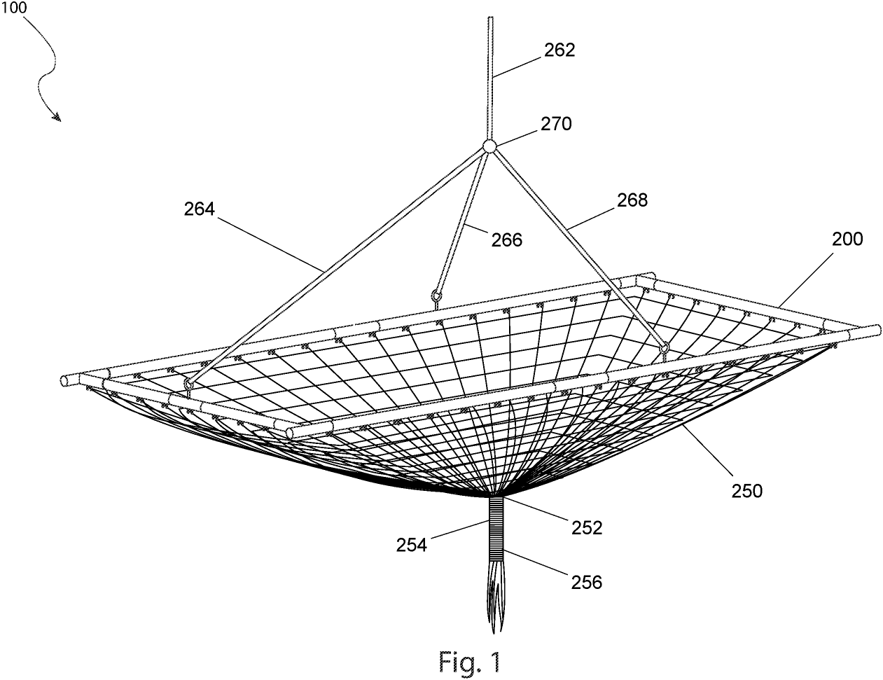

FIG. 2 is a top view of a framed three-point lift net 100, according to an embodiment of the present invention;

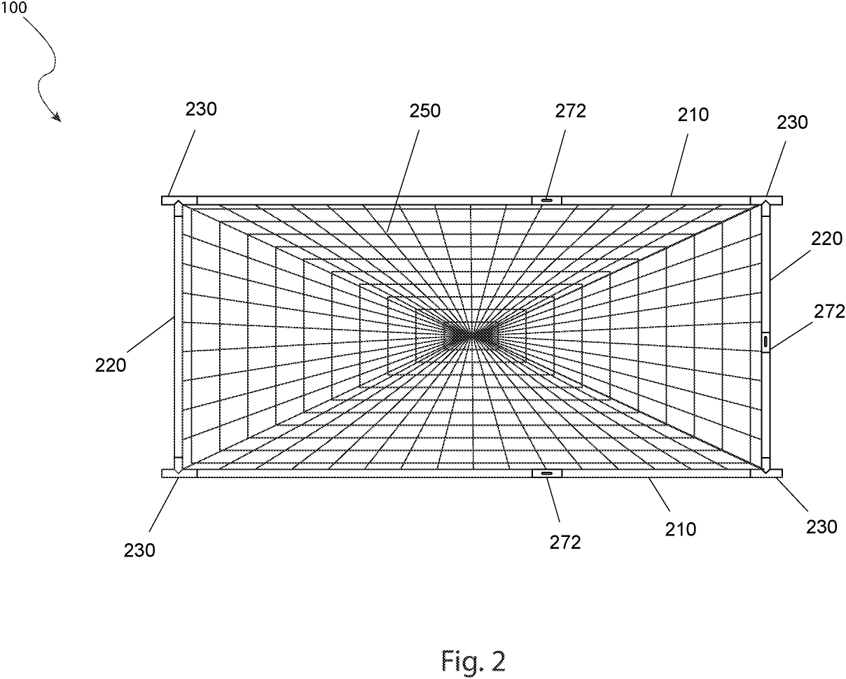

FIG. 3 is a side view of a framed three-point lift net 100, according to an embodiment of the present invention illustrating the frame 200 with the net 250 removed;

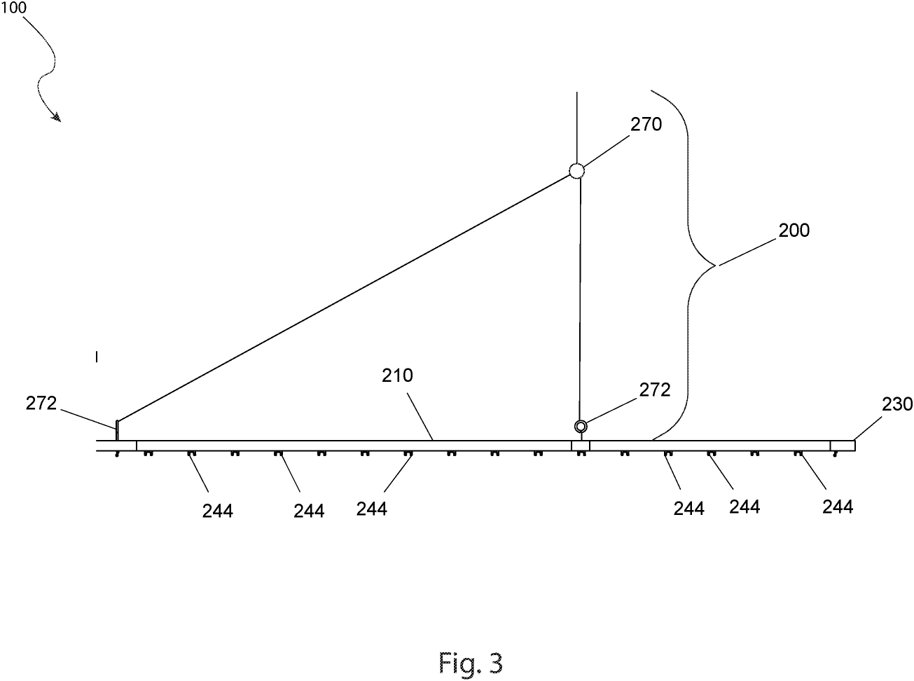

FIG. 4 is an in-use view of a framed three-point lift net 100, according to an embodiment of the present invention;

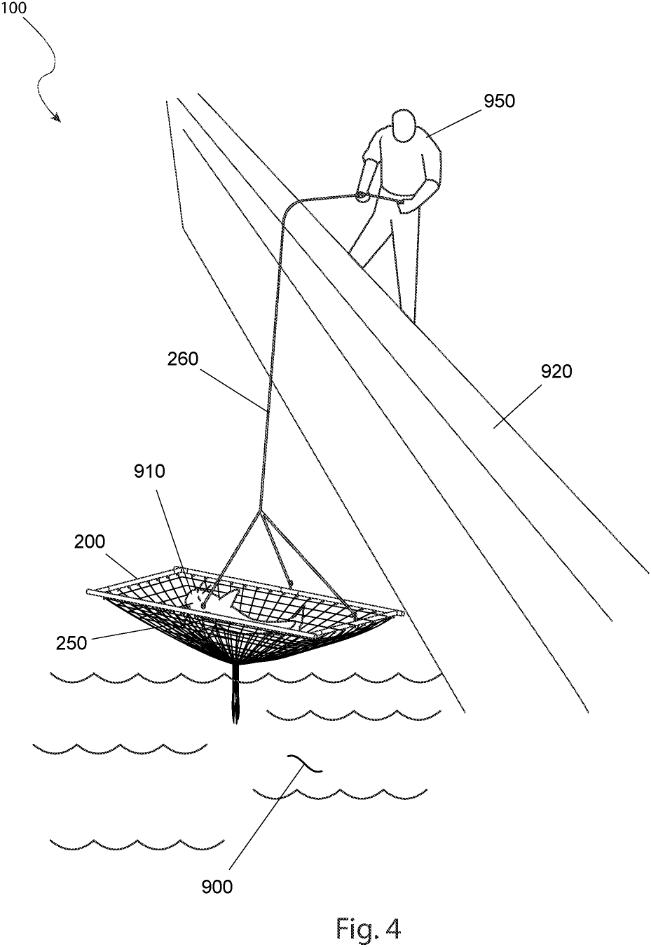

FIG. 5 is a detail view of a framed three-point lift net 100, according to an embodiment of the present invention illustrating a hinge 280 at the center of one (1) of the two (2) longitudinal frame tubes 210;

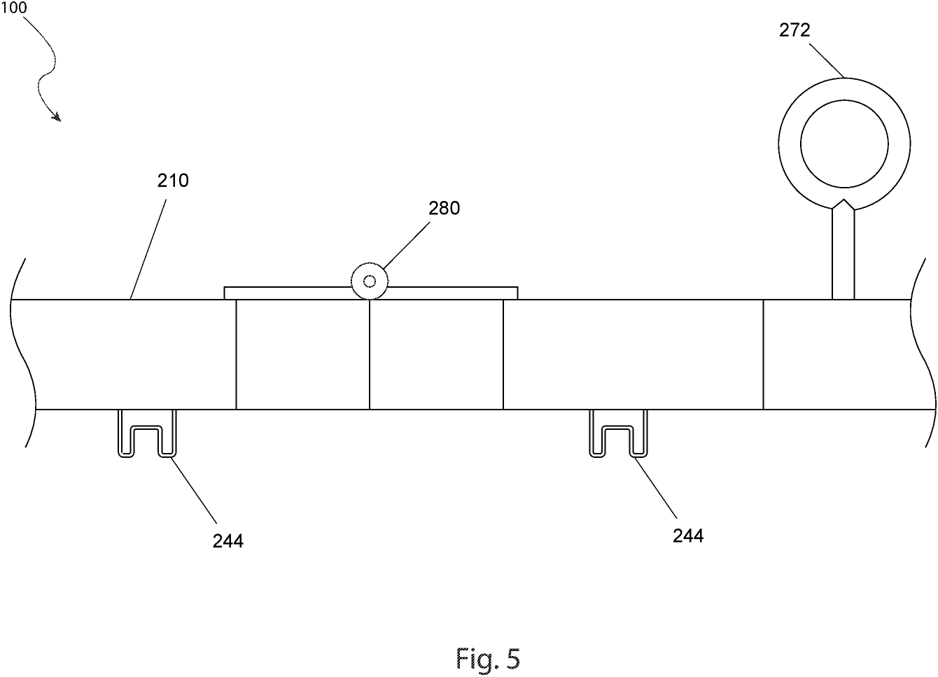

FIG. 6 is a top view of a framed three-point lift net 100, according to an embodiment of the present invention illustrating the frame 200 with the net 250 removed; and,

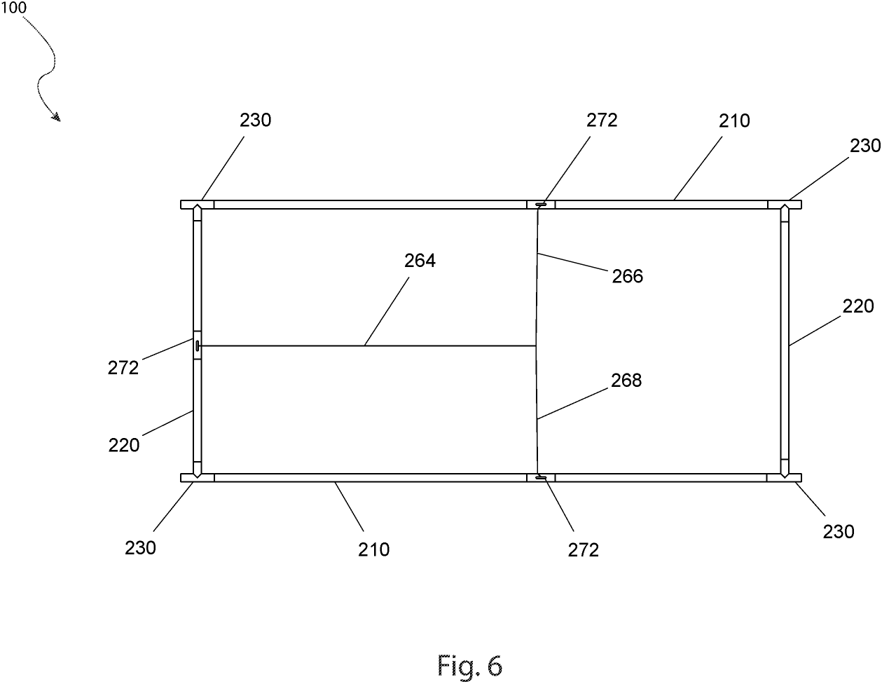

FIG. 7 is a front view of a framed three-point lift net 100, according to an embodiment of the present invention.

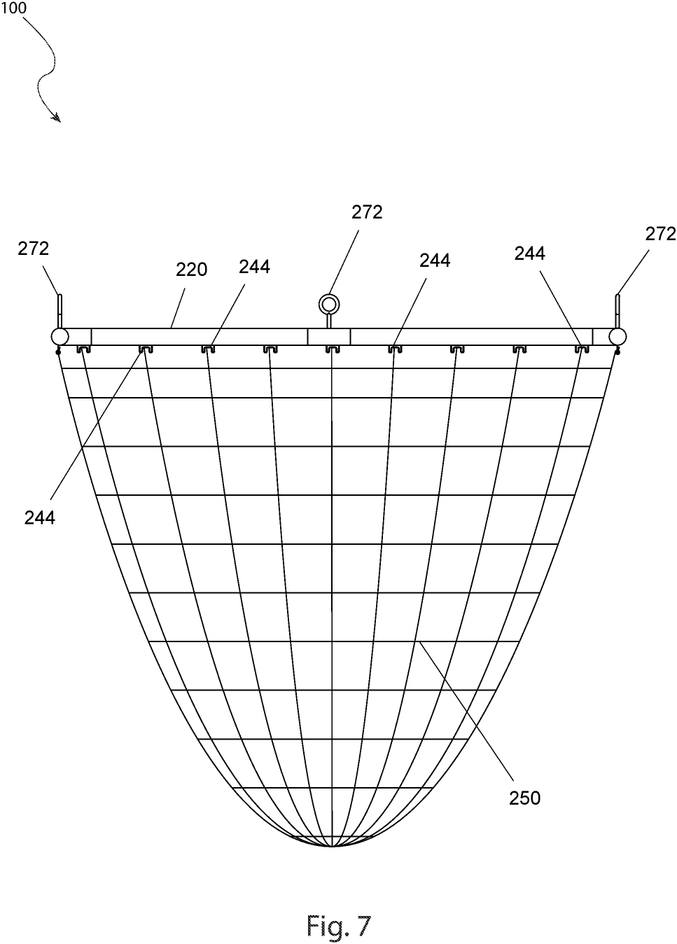

DESCRIPTIVE KEY

| | |
|---|---|
| 100 | framed three-point lift net |
| 200 | frame |
| 210 | longitudinal frame tube |
| 220 | lateral frame tube |
| 230 | corner coupler |
| 244 | netlock |
| 250 | net |
| 252 | center |
| 254 | center weight |
| 256 | tassel |
| 260 | lifting cord |
| 262 | main cord |
| 264 | longitudinal cord |
| 266 | first lateral cord |
| 268 | second lateral cord |
| 270 | junction point |
| 272 | eyelet |
| 280 | hinge |
| 900 | water |
| 910 | fish |
| 920 | elevated fishing venue |
| 950 | user |

### DESCRIPTION OF THE INVENTION

The present invention is directed to a framed three point lift net (herein described as the “invention”) 100. The invention 100 may comprise a frame 200, a net 250, and a lifting cord 260. The invention 100 may be a fishing net that is adapted to lift one (1) or more fish 910 out of water 900 and up to a user 950 located at an elevated fishing venue 920. As non-limiting examples, the elevated fishing venue 920 may be a pier, a bluff, a dam, or a boat. The net 250 may be held open by the frame 200. The net 250 may be adapted to be positioned under the one (1) or more fish 910 and then lifted as the frame 200 is raised by pulling up on the lifting cord 260. The lifting cord 260 may attach to the frame 200 at three (3) points.

The frame 200 may be a rigid rectangular support for the net 250. The frame 200 may comprise two (2) longitudinal frame tubes 210, two (2) lateral frame tubes 220, four (4) corner couplers 230, and plurality of net couplers. The two (2) longitudinal frame tubes 210 may be oriented to be parallel to each other. The two (2) lateral frame tubes 220 may be oriented to be parallel to each other and perpendicular to the two (2) longitudinal frame tubes 210. The two (2) longitudinal frame tubes 210 may be longer than the two (2) lateral frame tubes 220. An individual corner coupler selected from the four (4) corner couplers 230 may couple one (1) of the two (2) longitudinal frame tubes 210 to one (1) of the two (2) lateral frame tubes 220 at a corner of the frame 200.

The two (2) longitudinal frame tubes 210, the two (2) lateral frame tubes 220, and the four (4) corner couplers 230 may be hollow. The four (4) corner couplers 230 may be open to the water 900 such that the water 900 may fill the frame 200 in order to sink the frame 200 when the frame 200 is in the water 900. In some embodiments, the individual corner couplers 230 may be T-fittings. A first end of such a corner coupler 230 embodying an individual T-fitting may couple to one (1) of the two (2) longitudinal frame tubes 210, a second end of the T-fitting may couple to one (1) of the two (2) lateral frame tubes 220, and a third end of the T-fitting may be open to allow the water 900 to flow into the frame 200. In some embodiments, the frame 200 may be white in color so that the frame 200 is visible from the elevated fishing venue 920 while under the water 900.

The plurality of net couplers may be points of attachment between the net 250 and the frame 200. In some embodiments, the plurality of net couplers may comprise a plurality of frame apertures that may pass through the frame 200. Fibers from the net 250 may pass through one (1) or more of the plurality of frame apertures to couple the net 250 to the frame 200. In some embodiments, the plurality of net couplers may be a plurality of netlocks 244. As used herein, “netlock” 244 may refer to a type of spring that is operable to detachably couple a net 250 to a frame 200. As a non-limiting example, a plurality of netlocks 244 may detachably couple a basketball net to the rim of a basketball goal. The net 250 may detachably couple to the netlock 244 by passing a loop of the net 250 over the center of the netlock 244 and down until the loop slips behind the center bend of the netlock 244. The net 250 may be removed from the netlock 244 by pulling the loop of the net 250 out from behind the center bend of the netlock 244 and then pulling the loop out of the netlock 244.

The net 250 may be a mesh formed by weaving fibers into a grid-like structure. As non-limiting examples, the net 250 may be made from polyamides, polyester, or high-density polyethylene (HDPE). The spacing between the fibers of the net 250 may permit the water 900 to flow through the net 250 and may be adapted to prevent the one (1) or more fish 910 from passing through the net 250. The net 250 may be wider than the lateral width of the frame 200 and longer than the longitudinal length of the frame 200 such that when the frame 200 is held in a horizontal orientation the center 252 of the net 250 may hang below the plane of the frame 200.

In some embodiments, the center 252 of the net 250 may comprise a center weight 254 to pull the center 252 of the net 250 down. As a non-limiting example, the center weight 254 may comprise a tassel 256 formed from knotting ends of the net 250.

The lifting cord 260 may be coupled to the frame 200 and may be adapted to extend from the frame 200 to the user 950 located at the elevated fishing venue 920. The lifting cord 260 may comprise a main cord 262, a longitudinal cord 264, a first lateral cord 266, and a second lateral cord 268. A first end of the main cord 262, a first end of the longitudinal cord 264, a first end of the first lateral cord 266, and a first end of the second lateral cord 268 may be joined at a junction point 270. A second end of the main cord 262 may be adapted to extend to the user 950, making the main cord 262 the longest of the main cord 262, the longitudinal cord 264, the first lateral cord 266, and the second lateral cord 268. As a non-limiting example, the main cord 262 may be at least fifty feet (50 ft.) long. A second end of the longitudinal cord 264, a second end of the first lateral cord 266, and a second end of the second lateral cord 268 may be coupled to the frame 200 at three (3) points of attachment. The second end of the longitudinal cord 264 may be coupled to the center of one (1) of the two (2) lateral frame tubes 220. The second end of the first lateral cord 266 and the second end of the second lateral cord 268 may be coupled to the two (2) longitudinal frame tubes 210. In some embodiments, the second end of the first lateral cord 266 and the second end of the second lateral cord 268 may be coupled to the two (2) longitudinal frame tubes 210 at points that are located on the opposite half of the frame 200 from the point of attachment of the longitudinal cord 264 such that the frame 200 may be adapted to remain balanced when being lifted with the one (1) or more fish 910 in the net 250.

In some embodiments, the second end of the longitudinal cord 264, the second end of the first lateral cord 266, and the second end of the second lateral cord 268 may be tied to the frame 200. In some embodiments, the frame 200 may comprise a plurality of eyelets 272 for coupling the lifting cord 260 to the frame 200 and the second end of the longitudinal cord 264, the second end of the first lateral cord 266, and the second end of the second lateral cord 268 may be fastened to the plurality of eyelets 272.

In some embodiments, the two (2) longitudinal frame tubes 210 may comprise a pair of hinges 280 located at the center of each of the two (2) longitudinal frame tubes 210 such that the frame 200 may be folded in half while the net 250 remains coupled to the frame 200. Folding the frame 200 may reduce the size of the invention 100 for transportation and/or storage.

In a preferred embodiment, the frame 200 may be four feet with an error of one-half foot (4.0 +/- 0.5 ft.) in length by three feet with an error of one-half foot (3.0 +/- 0.5 ft.) in width. In some embodiments, the frame 200 may be constructed from one inch (1 in.) schedule 80 PVC pipe.

In use, a user 950 located at an elevated fishing venue 920 may drop the frame 200 and the net 250 into the water 900 while retaining the end of the lifting cord 260. Using the lifting cord 260, the user 950 may position the net 250 under the one (1) or more fish 910, facilitated by the positioning of the three points of attachment of the lifting cord 260 to the frame 200 which leaves one (1) end of the frame 200 free from interference by the lifting cord 260. With the net 250 beneath the one (1) or more fish 910, the user 950 may pull on the lifting cord 260 to raise the frame 200 and the net 250. The user 950 may lift the net 250 until the net 250 and the one (1) or more fish 910 are landed at the elevated fishing venue 920.

The exact specifications, materials used, and method of use of the invention 100 may vary upon manufacturing. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A framed three-point lift net device for lifting one or more fish out of the water, the device comprising:
a frame;
a net, wherein the net configured to be coupled to the frame, wherein the net is held in an open position by the frame; and
a lifting cord, wherein the lifting cord is configured to be pulled upwards to lift the one or more fish to a user at an elevated fishing venue.

2. The device according to claim 1, wherein the elevated fishing venue is a pier.

3. The device according to claim 1, wherein the elevated fishing venue is a bluff.

4. The device according to claim 1, wherein the frame is a rigid support.

5. The device according to claim 1, wherein the frame be a white color.

6. The device according to claim 1, wherein the rigid support being a rectangular shape.

7. The device according to claim 1, wherein the frame further comprising:
two (2) longitudinal frame tubes, wherein a first of the longitudinal tubes is configured to be oriented parallel to a second of the longitudinal tubes;
two (2) lateral frame tubes, wherein a first of the lateral frame tubes being configured to be parallel to a second of the lateral frame tubes, and wherein the lateral tubes being perpendicular to the longitudinal frame tubes;
four (4) corner couplers, wherein a first two of the corner couplers being configured to couple one of the longitudinal frame tubes to one of the lateral frame tubes forming a corner of the frame; and
a plurality of net couplers.

8. The device according to claim 7, wherein the net couples are configured to be point of attachment between the net and the frame.

9. The device according to claim 7, wherein the longitudinal frame tubes being longer than the lateral frame tubes.

10. The device according to claim 7, wherein the longitudinal frame tubes are hollow.

11. The device according to claim 7, wherein the lateral frame tubes are hollow.

12. The device according to claim 7, wherein the corner couplers are a t-fitting.

13. The device according to claim 12, wherein each of the t-fitting corner couplers being coupled to one of the longitudinal frame tubes and a second end of the t-fitting corner couplers being coupled to one of the lateral frame tubes and a third end of the t-fitting corner coupler be in an open position to allow water to flow into the frame.

14. The device according to claim 7, wherein the net couples are a plurality of frame apertures that pass through the frame.

15. The device according to claim 15, wherein one or more fibers of the net being passed through at least one of the frame apertures.

16. The device according to claim 7, wherein the longitudinal frame tubes comprising a pair of hinges located at a center of each of the longitudinal frame tubes, wherein the frame is foldable in half while the net being coupled to the frame.

17. The device according to claim 1, wherein the lifting cord be coupled to the frame and wherein the lifting cord is adapted to extend from the frame to user located at the elevated fishing venue.

18. The device according to claim 1, wherein the lifting cord comprising:
a main cord, the main cord having a first end and a second end;
a longitudinal cord, the longitudinal cord having a first end and a second end;
a first lateral cord, the first lateral cord having a first end and a second end; and
a second lateral cord, the second lateral cord having a first end and a second end, wherein
a first end of the main cord, a first end of the longitudinal cord, a first end of the first lateral cord and a first end of the second lateral cord being joined at a junction point.

19. The device according to claim 18, wherein the second end of the main cord being configured to extend to the user.

20. The device according to claim 18, wherein the main cord being at least fifty (50) feet in length.
